(19) United States
(12) Patent Application Publication
(10) Pub. No.: US 2014/0212530 A1
(43) Pub. Date: Jul. 31, 2014

(54) METHOD FOR MANUFACTURING IMPRINT MOLD AND RESIST DEVELOPING DEVICE

(71) Applicants: Hideo Kobayashi, Shinjuku-ku (JP); Hiromasa Iyama, Shinjuku-ku (JP)

(72) Inventors: Hideo Kobayashi, Shinjuku-ku (JP); Hiromasa Iyama, Shinjuku-ku (JP)

(73) Assignee: HOYA CORPORATION, Shinjuku-ku, Tokyo (JP)

(21) Appl. No.: 14/241,960

(22) PCT Filed: Aug. 31, 2012
(86) PCT No.: PCT/JP2012/072182

§ 371 Date: Apr. 7, 2014

(30) Foreign Application Priority Data
Sep. 7, 2011 (JP) 2011-195280

(51) Int. Cl. B29C 39/38

(52) U.S. Cl. CPC B29C 39/38
USPC 425/143; 264/28

(57) ABSTRACT

A resist developing device is provided, including: a storage part configured to store the developing solution, with a temperature controlled to a constant temperature; a holding part configured to hold the substrate to be processed; a supply pipe configured to form a flow passage for flowing the developing solution stored in the storage part, and having a discharging part for discharging the developing solution flowed through the flow passage, and configured to supply the developing solution to the substrate to be processed by discharging the developing solution from the discharging part toward the substrate to be processed which is held by the holding part; and a position-change part configured to perform the first position-change operation for varying a discharging direction of the discharging part in a non-reaching direction for not allowing the developing solution discharged from the discharging part of the supply pipe to reach the substrate to be processed, and a second position-change operation for varying the discharging direction of the discharging part in a reaching direction for allowing the developing solution discharged from the discharging part of the supply pipe to reach the substrate to be processed.

### BACKGROUND

1. Technical Field

The present invention relates to a method for manufacturing an imprint mold and a resist developing device for supplying a developing solution.

2. Description of Related Art

A resist developing device used in a lithography field is known (for example, see patent document 1). The resist developing device is the device of dissolving an unnecessary portion of a resist film by supplying the developing solution to an exposed resist film.

In recent years, with high integration of a semiconductor device, improvement of a resolution of a development is strongly desired. When the resist film is developed (also called “resist development” hereafter), the unnecessary portion of the resist film is removed by the developing solution as described above. However, sagging is sometimes caused in an edge portion of a resist pattern (called simply “pattern” hereafter) during development. As a result, a corner of the edge portion of a pattern collapses in out-of-shape state, thus causing a reduction of the resolution.

Therefore, as a technique of improving the resolution of the resist development, a method of developing a resist film using a “developing solution with low temperature” lower than a normal temperature (called a “low temperature developing method” hereafter”) is known (for example see patent document 2). If the resist film is developed using the low temperature developing solution, sagging is hardly caused in the edge portion of the pattern during development. As a result, the collapse of the edge portion of the pattern in the out-of-shape state is suppressed, and the resolution can be improved. The “normal temperature” described in this specification indicates the “temperature within a range of 15° C. to 25° C.”. Accordingly, the temperature of the developing solution used in the low temperature developing method is less than 15° C.

### PRIOR ART DOCUMENT

### Patent document

Patent document 1: Japanese Patent Laid Open Publication No. 1999-154641
Patent document 2: Japanese Patent Laid Open Publication No. 1995-142322

### SUMMARY OF THE INVENTION

### Problem to be Solved by the Invention

In recent years, for example, in a field of a nano-imprint, formation of a fine irregular pattern of a nano-level is required, irrespective of a resist pattern or a pattern engraved on a substrate. In order to form such a fine irregular pattern with high precision, the temperature of the developing solution is required to be set to a specific temperature depending on the kind of a resist.

However, if the temperature of the developing solution is low as described above, a difference between the temperature required for the developing solution and the temperature of a setting place, etc., of a resist developing device (called an “environment temperature” hereafter) becomes large, thus it may causes the following difficulties.

Generally, the resist developing device is configured to store the developing solution in a storage part and control the temperature to a constant (desired) temperature, and supply the developing solution to the substrate to be processed through a pipe (called a “supply pipe” hereafter) for supplying the developing solution from the storage part. When the resist developing device is thus configured, even if the temperature of the developing solution stored in the storage part is controlled to the specific (desired) temperature, the temperature of the developing solution is easily influenced by the environment temperature, thereby possibly causing a variation in the temperate during supply of the developing solution to the substrate to be processed through the supply pipe from the storage part. As a result, there is a risk of damaging stability and uniformity in development processing, due to a temperature variation in the developing solution. Specifically, there is a risk of causing an unevenness of development in the same (one) substrate to be processed, and causing the variation of development to occur in different substrates to be processed.

Therefore, in order to solve the abovementioned problem, the present invention is provided, and an object of the present invention is to provide a method for manufacturing an imprint mold and a resist developing device capable of suppressing the temperature variation of the developing solution actually supplied to the substrate to be processed, and stably applying processing to the substrate to be processed including the step of supplying the developing solution.

### Means for Solving the Problem

According to an aspect of the present invention, there is provided a method for manufacturing an imprint mold for forming an irregular pattern on a substrate to be processed, using a development processing performed by discharging a developing solution to the substrate to be processed through a supply pipe, the method including:

a first position-change operating step of discharging the developing solution by varying a discharging direction in a non-reaching direction for not allowing the developing solution to reach the substrate to be processed when a temperature of the developing solution in the supply pipe is not within a suitable temperature range; and

a second position-change operating step of discharging the developing solution by varying the discharging direction in a reaching direction for allowing the developing solution to reach the substrate to be processed, when the temperature of the discharged developing solution is within a suitable temperature range, after the first position-change operating step.

According to a second aspect of the present invention, there is provided the method of the first aspect, wherein the first position-change operating step and the second position-change operating step are performed in case of the longer time period than an allowable one between the finishing the preceding substrate development processing and the executing the next substrate development processing.

According to a third aspect of the present invention, there is provided the method of the second aspect, including:

performing the first position-change operating step and the second position-change operating step in a period from applying the development processing to the one preceding substrate to be processed until the development processing is applied to the next substrate to be processed.

According to a fourth aspect of the present invention, there is provided the method of the third aspect, wherein in the first position-change operating step, a total amount or more of the developing solution remained in the supply pipe is discharged without allowing it to reach the substrate to be processed.

According to a fifth aspect of the present invention, there is provided the method of the fourth aspect, wherein the substrate to be processed is a mold substrate for nano-imprint.

According to a sixth aspect of the present invention, there is provided the method of the fifth aspect, wherein the suitable temperature range is 0° C. or less.

According to a seventh aspect of the present invention, there is provided a resist developing device for applying development processing to a substrate to be processed by supplying a developing solution to the processed substrate: the device including:

a storage part configured to store the developing solution, with a temperature controlled to a constant temperature;

a holding part configured to hold the substrate to be processed;

a supply pipe configured to form a flow passage for flowing the developing solution stored in the storage part, and having a discharging part for discharging the developing solution flowed through the flow passage, and configured to supply the developing solution to the substrate to be processed by discharging the developing solution from the discharging part toward the substrate to be processed which is held by the holding part; and

a position-change part configured to perform the first position-change operation for varying a discharging direction of the discharging part in a non-reaching direction for not allowing the developing solution discharged from the discharging part of the supply pipe to reach the substrate to be processed, and a second position-change operation for varying the discharging direction of the discharging part in a reaching direction for allowing the developing solution discharged from the discharging part of the supply pipe to reach the substrate to be processed.

According to an eighth aspect of the present invention, there is provided the resist developing device of the seventh aspect, wherein in the first position-change operation, a total amount or more of the developing solution remained in the supply pipe before the first position-change operation, is discharged from the discharging part without allowing it to reach the substrate to be processed.

According to a ninth aspect of the present invention, there is provided the device of the eighth aspect, wherein a temperature adjuster is provided at a part of the supply pipe.

According to a tenth aspect of the present invention, there is provided the device of the ninth aspect, wherein the substrate to be processed which is an object to which the developing solution is supplied, is a mold substrate for nano-imprint.

According to an eleventh aspect of the present invention, there is provided the device of the tenth aspect, wherein the temperature of the developing solution stored in the storage part is controlled to a low temperature of 0° C. or less.

### Effect of the Invention

According to the present invention, processing can be stably applied to the substrate to be processed including the step of supplying the developing solution, by suppressing the temperature variation of the developing solution actually supplied to the substrate to be processed.

### BRIEF DESCRIPTION OF THE DRAWINGS

FIG. 1 is a schematic view showing the whole structure of a resist developing device.

FIG. 2 is a view showing a example of a jacket structure.

FIG. 3 is a view showing a structure of an essential portion of the resist developing device according to an embodiment of the present invention.

### DETAILED DESCRIPTION OF THE INVENTION

Embodiments of the present invention will be described in detail hereafter, regarding a method for manufacturing an imprint mold and a resist developing device used in a photolithography field, with reference to the drawings.

An embodiment of the present invention will be described in the following order.

1. The whole structure of a resist developing device

2. Structure of an essential portion of the resist developing device

3. Operation of the resist developing device (method for manufacturing an imprint mold)

4. Effect of the embodiment

<1. The Whole Structure of a Resist Developing Device>

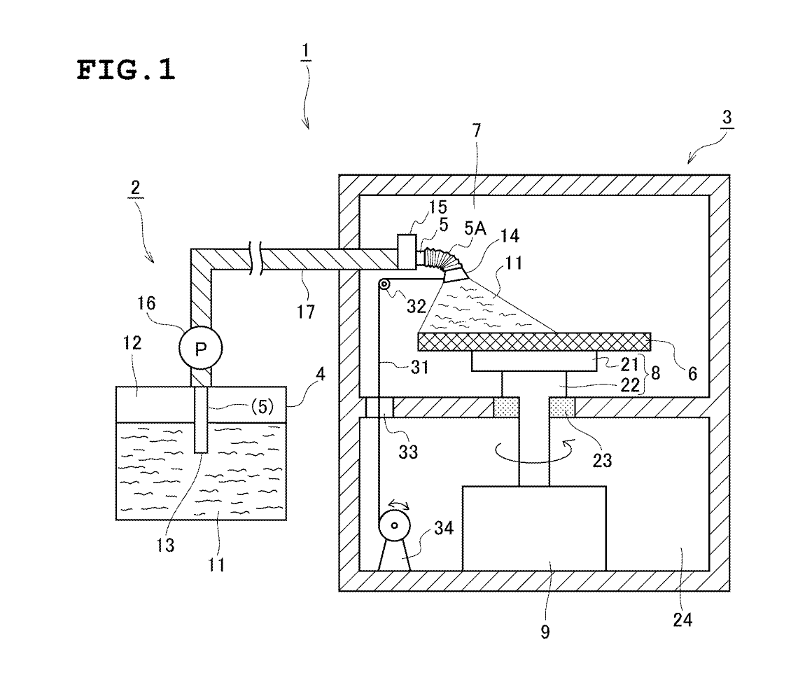

FIG. 1 is a schematic view showing the whole structure of a resist developing device 1 according to an embodiment of the present invention. A resist developing device shown in the figure is configured to roughly include a developing solution supply part 2 and a development processing part 3.

The developing solution supply part 2 is a portion for supplying a developing solution required for development processing performed by the development processing part 3. The developing solution supply part 2 includes a storage part for storing the developing solution and a supply pipe 5 for supplying (transporting) the developing solution.

The development processing part 3 is a portion for applying development processing to the substrate 6 to be processed. The development processing part 3 includes at least a processing chamber 7 having a space for the development processing, a holding part 8 for holding the substrate 6 to be processed in the processing chamber 7, and a rotation drive part 9 for rotary-driving the holding part 8. The structures of the developing solution supply part 2 and the development processing part 3 will be described further in detail hereafter.

(Structures of the Developing Solution Supply Part 2)

Although not specifically shown, the storage part 4 has a tank structure so as to substantially thermally air-tightly close the inside of the tank body by a lid member, including a tank body with an upper portion or apart of the upper portion opened and outside of an inner wall made of a heat insulating material, and also including the lid member with outside of its inner wall made of a heat insulating material. Namely, the storage part 4 has substantially an air-tightly closed type tank structure covered with the heat insulating material. A suitable amount of developing solution 11 is housed (stored) in the storage part 4. The developing solution in a liquid state is used at an estimated set temperature. An upper space above a liquid face of the developing solution 11 in the storage part 4 is the space 12 thermally substantially air-tightly closed by the abovementioned lid member (called an “air-tightly closed space” hereafter).

The developing solution 11 stored in the storage part 4 is controlled in a constant temperature state by a liquid temperature controller not shown. Although not shown for example, a specific mode of the liquid temperature controller is considered as follows: the mode of stirring the developing solution 11 in the storage part 4 by a stirrer, and cooling the developing solution 11 by a cooler and a heater disposed in the tank, to thereby maintain the temperature of the developing solution 11 to a previously set temperature (called a “set temperature” hereafter). Further, as another mode, the mode of making a part of the supply pipe 5 on a downstream side of the storage part 4 sink as a heat exchanging coil, into a heating medium of the constant temperature tank with its temperature controlled to the previously set temperature, to thereby control the temperature of the developing solution passing through the heat exchanging coil. Even in a case of employing whichever mode, the temperature of the developing solution 11 in the storage part 4 is controlled to fall within an allowable range (for example, within ±0.1° C.) in which the set temperature (for example −10°) is selected as a central value.

The supply pipe 5 is configured to supply the developing solution 11 stored in the storage part 4 toward the substrate 6 to be processed. The substrate 6 to be processed is set in the processing chamber 7 of the development processing part 3. The substrate 6 to be processed which is an object to which the development processing is applied, is the substrate having an exposed resist film. Further, as an example of the substrate 6 to be processed, the substrate for fabricating mold for nano-imprint can be given. The substrate for fabricating mold for nano-imprint (called simply a “mold substrate” hereafter) is the substrate becoming a mold corresponding to a master pattern mold when transfer of the pattern is performed by a nano-imprint method. The mold corresponding to the master pattern mold is not limited to the nano-imprint method and indicates the “mold substrate for imprint”. Then, the mold substrate for imprint is also called an imprint mold.

The supply pipe 5 is formed using a long hollow pipe with a circular cross-sectional face. One end portion of the supply pipe 5 is formed into a take-in part 13 opened for taking-in the developing solution 11, and the other end portion is formed into a discharging portion 14 opened for discharging the developing solution 11.

Further, as shown in FIG. 1, a hollow bellow part 5A having approximately the same diameter as the diameter of the supply pipe 5 and having flexibility, air-tightness, and spring property (elasticity), is provided in a former part of the discharging pipe 14, so as to freely vary a discharging direction of the liquid supplied from the discharging part 14. The elasticity of the bellow part 5A works so that the hollow portion always keeps a horizontal state, and works so as to repel against a curve from the horizontal state. Further, for example a metal material is selected as the material of the bellow part 5A according to the material of the supply pipe 5.

The bellow part 5A may be formed integrally with the supply pipe 5, or may be formed separately from the supply pipe 5 and thereafter may be formed integrally with the supply pipe 5 by bonding, wherein the bellow part 5A is preferably formed integrally with the supply pipe 5 from a viewpoint of preventing a mixture of impurities from a bonded portion. A position-change control mechanism and a position-change control operation of the discharging direction of the discharging part 14, which is realized by providing the abovementioned bellow part 5A on the supply pipe 5, will be described later in detail.

The discharging part 14 may be simply one opening or may have a structure like a shower head with a plurality of small openings provided. Further, the discharging part 14 may also have a structure like a spray nozzle tip for discharging the developing solution 11 in a spray shape. Here, as an example, the bellow part 5A is provided for varying the discharging direction of a liquid supplied from the discharging part 14 of the supply pipe 5. However, the other structure that can vary the discharging direction may also be employed.

The take-in part 13 of the supply pipe 5 is disposed in the storage part 4 of the developing solution supply part 2. Further, the discharging part 14 of the supply pipe 5 is disposed in the processing chamber 7 of the development processing part 3. In addition, the supply pipe 5 is laid so as to form the flow passage of the developing solution 11 between the take-in part 13 as an uppermost stream part, and the discharging part 14 as a lowermost stream part.

Specifically, the supply pipe 5 is laid so as to be introduced to outside from inside of the storage part 4. Further, an introducing portion of the supply pipe 5 outside of the storage part 4 is disposed to pass through an outer wall portion of the development processing part 3 and advance into the processing chamber 7, up to a position facing the holding part 8 in the processing chamber 7. The position facing the holding part 8 is the position where the developing solution 11 discharged from the discharging part 14 of the supply pipe 5 can be supplied to the substrate 6 to be processed held by the holding part 8. In the example shown in the figure, the discharging part 14 positioned on the lowermost stream of the supply pipe 5 is disposed right above the substrate 6 to be processed held by the holding part 8.

Further, an open/close valve 15 and a pump 16 are provided in the middle of the piping of the supply pipe 5. The open/close valve 15 is disposed inside of the processing chamber 7. The reason for disposing the open/close valve 15 inside of the processing chamber 7 is as follows. Namely, a piping portion (piping portion exposed to outside) of the supply pipe 5 that extends to the downstream side of a part where the open/close valve 15 is fitted, is a temperature variation factor of the developing solution 11 that is stored in there or flows through this piping portion. Accordingly, in order to suppress the temperature variation of the developing solution 11, it is effective to shorten a length of the piping portion of the supply pipe 5 that extends to the downstream side of the part where the open/close valve 15 is fitted. Therefore, the open/close valve 15 is disposed inside of the processing chamber 7 so as to be positioned close to the discharging part 14 as much as possible. The pump 16 is disposed outside of the storage part 4. Both of the open/close valve 15 and the pump 16 are members for controlling a flow of the developing solution 11 through the supply pipe 5.

Namely, when the developing solution 11 is supplied through the supply pipe 5, the open/close valve 15 allows the flow of the developing solution 11 by setting a pipeline of the supply pipe 5 in an open state, and inhibits the flow of the developing solution 11 by setting the pipeline of the supply pipe 5 in a close state. When the flow of the developing solution 11 is allowed by the open/close valve 15, supply of the developing solution 11 is started through the supply pipe 5. Further, when the flow of the developing solution 11 is inhibited by the open/close valve 15, supply of the developing solution 11 through the supply pipe 5 is stopped. Accordingly, the open/close valve 15 is the member that functions to start or stop the supply of the developing solution 11.

When the pump 16 is actually driven, the pump 16 generates a power for causing the flow of the developing solution 11 along the supply pipe 5. The pump 16 adds a pressure on the developing solution 11 for sucking and transferring the developing solution 11, when supplying the developing solution 11 through the supply pipe 5. Namely, the pump 16 functions as a drive source for sucking the developing solution 11 stored in the storage part 4 into the supply pipe 5, and transfer the sucked developing solution 11 thorough the supply pipe 5. Therefore, although flow of the developing solution 11 inside of the supply pipe 5 is not formed in a state that drive of the pump 16 is stopped (off-state), flow of the developing solution 11 is formed inside of the supply pipe 5, in a state that the drive of the pump 16 is started or continued (on-state). Note that as a linked operation of the open/close valve 15 and the pump 16, for example the pump 16 is operated first and immediately thereafter the open/close valve 15 is opened for starting the supply of the developing solution 11 and the discharge of the developing solution 11 from the discharging part 14. Further, the open/close valve 15 is closed and immediately thereafter the pump 16 is stopped for stopping the supply of the developing solution 11 or stopping the discharge of the developing solution 11 from the pump discharging part 14. Thus, a constant pressurized state is maintained in the developing solution 11 in the supply pipe 5, and operations of supply (discharge) and stop of the developing solution 11 can be instantaneously and stably performed. An open/close state of the open/close valve 15 and a drive (on/off) state of the pump 16 can be controlled by a main control part of a resist developing device not shown for example.

The supply pipe 5 introduced to the outside of the storage part 4 is covered with a jacket 17. The jacket 17 is provided at a part of the supply pipe 5 as an example of the temperature adjuster. The jacket 17 is interposed between the supply pipe 5 and an outer air (atmosphere) around the supply pipe 5, and has a function (cooling function) of adjusting a temperature, so that the developing solution in the supply pipe 5 is maintained in the same temperature (set temperature) as the temperature in the storage part 4 by flowing and circulating a coolant around the supply pipe 5 in a case of a low temperature development. The jacket 17 has a multiple pipe structure (including a double or triple or more pipe structure) with the supply pipe 5 as a center.

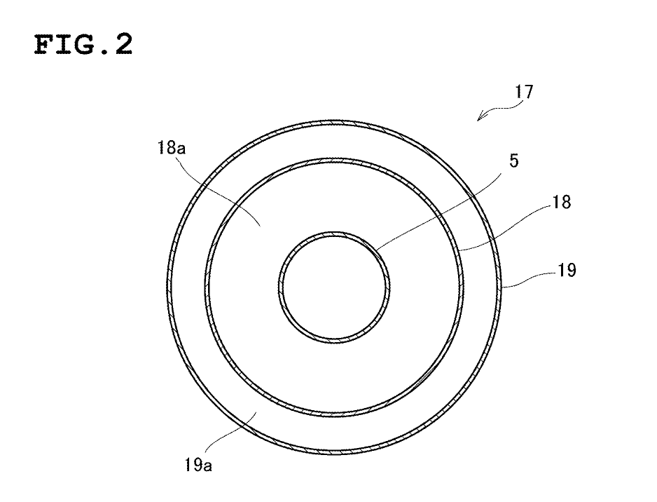

As an example, as shown in FIG. 2, the jacket 17 has a triple pipe structure including the supply pipe 5 inside. The supply pipe 5 is a pipe positioned at innermost side and a second pipe 18 having a larger diameter than the diameter of the supply pipe 5 is disposed outside of the supply pipe 5, and a third pipe 19 having a larger diameter than the diameter of the second pipe 18 is disposed further outside (namely outermost side) of the second pipe 18. In the jacket 17 thus having the triple pipe structure, for example a liquid coolant is circulated between an outer peripheral surface of the supply pipe 5 and an inner peripheral surface of the second pipe 18 so as to form a cooling layer 18a in this place. Further, for example air (preferably cool air) is circulated between the outer peripheral surface of the second pipe 18 and an inner peripheral surface of the third pipe 19 so as to form a heat insulating layer 19a in this place.

The jacket 17 is provided in a state of covering the supply pipe 5 in an appearance of continuing to a piping portion extending from the storage part 4 to the processing chamber 7 of the development processing part 3, and continuing to a piping portion up to a position facing the holding part 8 in the processing chamber 7. Further, the jacket 17 is provided in the state of covering the supply pipe 5 at the abovementioned piping portion extending from the storage part 4 to the processing chamber 7 of the development processing part 3, excluding an attachment part of the open/close valve 15 and an attachment part of the pump 16. Further, the jacket 17 is provided inside of the processing chamber 7, with the attachment part of the open/close valve 15 as a terminal end position.

(Structure of the Development Processing Part 3)

As described above, the development processing part 3 includes the processing chamber 7, the holding part 8, and the rotation drive part 9. Among these parts, the holding part 8 is constituted using a spin chuck 21 for supporting the substrate 6 to be processed in a fixed state and a spindle shaft 22 connected to the spin chuck 21. The spin chuck 21 is formed into a circular shape in planer view similar to the substrate 6 to be processed, if the substrate 6 to be processed is assumed to have a disc shape. In the example shown in the figure, the outer diameter of the spin chuck 21 is smaller than the outer diameter of the substrate 6 to be processed. However, a large/small relation of both of them is not limited thereto, and mutually the same outer diameter is acceptable and a large/small relation opposite to the example in the figure is also acceptable. Further, the planer shape of the spin chuck 21 is not limited to the circular shape and may be a polygonal shape including a rectangular shape.

The spin chuck 21 is disposed horizontally to a surface (upper surface of the spin chuck in the example of the figure) of the side opposite to the substrate 6 to be processed. The spin chuck 21 supports the substrate 6 to be processed from a lower surface side in a state of placing the substrate 6 to be processed on its upper surface. Further, the spin chuck 21 is configured to fix the substrate 6 to be processed in a vacuum suction system. Such a support structure by the spin chuck 21 is not limited to the vacuum suction system given here, and it is also acceptable to support the substrate 6 to be processed in a fixed state by other system (for example, by an support and hold system using a pin, etc.).

The spindle shaft 22 is the shaft which is rotary-driven by a drive force of the rotation drive part 9. The spindle shaft 22 is connected to a central portion at a lower surface side of the spin chuck 21 using a means such as coupling, etc. Therefore, if the spindle shaft 22 is rotated, the spin chuck 21 is rotated integrally with the spindle shaft 22. The spindle shaft 22 is disposed in a state passing through a bottom wall of the processing chamber 7 partitioned by a box-shaped wall.

Further, a seal member 23 is provided at a penetration part of the spindle shaft 22 on the bottom wall of the processing chamber 7. The seal member 23 has a function of preventing a leak of a liquid (including the developing solution 11) to outside of the processing chamber 7 from the penetration part of the spindle shaft 22 while allowing the rotation of the spindle shaft 22.

The rotation drive part 9 is disposed in a lower chamber 24 partitioned from the processing chamber 7 by a wall. Although not shown for example, the rotation drive part 9 is configured using a motor which is a drive source of rotation, and a drive force transmitting mechanism (such as a gear train, etc.) for transmitting the drive force of the motor to the spindle shaft 22.

Although not shown in FIG. 1, the resist developing device 1 includes a rinse liquid supply part as a supplementary function part. The rinse liquid supply part is the function part for supplying a rinse liquid to the substrate 6 to be processed after development processing and applying rinse processing thereto.

<2. Structure of an Essential Part of the Resist Developing Device>

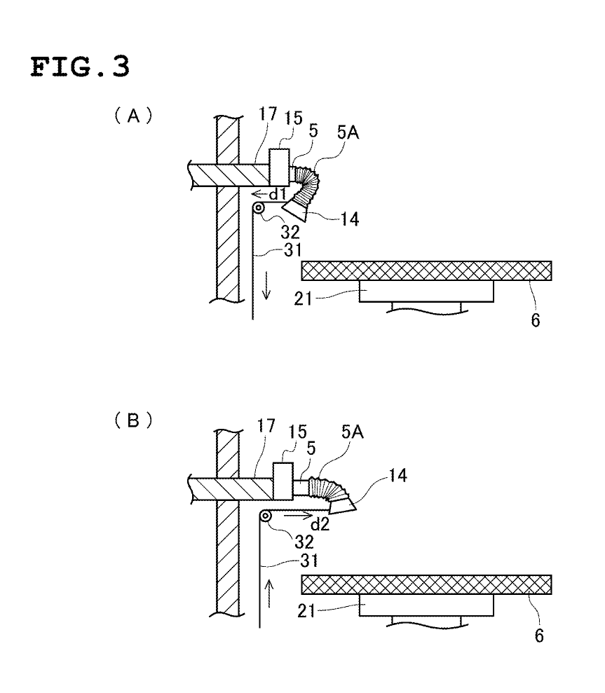

FIG. 3 is a view showing the structure of an essential part of the resist developing device 1 according to an embodiment of the present invention, and FIG. 3(A) and FIG. 3(B) are views showing a state that discharging directions of the discharging part 14 of the supply pipe 5 are varied in the non-reaching direction and the reaching direction to the substrate 6 to be processed of the developing solution described later. As shown in FIG. 3, the supply pipe 5 includes the bellow part 5A having flexibility, air-tightness, and spring property (elasticity) at the joint of the discharging part 14 so that the discharging direction of the liquid supplied from the discharging part 14 can be freely varied.

Further, as shown in FIG. 1, wire 31 is attached to the discharging part 14 of the supply pipe 5 by a hook mechanism not shown, so as to extend approximately in a horizontal direction. The wire 31 is attached to a direction converting mechanism 32 for varying a direction of a force in a vertical direction from a horizontal direction (in other words, in the horizontal direction from the vertical direction) while being freely rotated like a pulley.

Thus, the wire 31 with direction varied in the vertical direction from the horizontal direction, is arranged so as to pass through the bottom wall of the processing chamber 7 to the lower chamber 24. In addition, a seal member 33 is provided at the penetration part of the wire 31 on the bottom wall of the processing chamber 7. The seal member 33 has a function of preventing the leak of the liquid (including the developing solution 11) to the outside of the processing chamber 7 from the penetration part of the wire 31 while allowing a movement of the wire 31 in the vertical direction.

The drive part 34 is disposed on a bottom portion of the lower chamber 24, and controls the movement of the wire 31 in the vertical direction. Specifically, although not shown, the drive part 34 is configured for example using a motor which is the drive source and a drive force transmitting mechanism (such as a rotation wind-up mechanism) for transmitting the drive force of the motor to the wire 31. When the operation of the drive part 34 is controlled to pull the wire 31 vertically downward, the direction of the force of the wire 31 is converted to d1 direction shown in FIG. 3(A), to thereby vary the discharging direction of the discharging part 14. Further, when the operation of the drive part 34 is controlled to loosen the wire 31 vertically upward, the direction of the force of the wire 31 is converted to d2 direction shown in FIG. 3(B) by an elastic force of the bellow part 5A, to thereby vary the discharging direction of the discharging part 14.

A position-change mechanism, which is a “position-change part” for varying the discharging direction of the discharging part 14 of the supply pipe 5, is configured including the wire 31, the direction converting mechanism 32, and the drive part 34, so that the developing solution 11 discharged from the discharging part 14 can reach or not reach the substrate 6 to be processed, according to a situation described later.

Further, the position-change mechanism is not necessarily required to be configured including the wire 31, the direction converting mechanism 32, and the drive part 34, and may be a structure capable of varying the discharging direction of the developing solution discharged from the discharging part 14 of the supply pipe 5. As the discharging direction of the discharging part 14 of the supply pipe 5, the “non-reaching direction” for not allowing the developing solution to reach the substrate 6 to be processed, and the “reaching direction” for allowing the developing solution to reach the substrate 6 to be processed are set, so that the discharging direction can be freely varied by the position-change mechanism.

Here, the non-reaching direction and the reaching direction will be described.

The non-reaching direction is the direction for not allowing the developing solution 11 discharged from the discharging part 14 of the supply pipe 5 to reach the substrate 6 to be processed. Specifically, the non-reaching direction is the direction as follows: by varying the discharging direction of the discharging part 14 of the supply pipe 5 as shown in FIG. 3(A) so as not to allow the developing solution 11 discharged from the discharging part 14 of the supply pipe 5 to reach the substrate 6 to be processed, supply of the developing solution 11 to the substrate 6 to be processed is inhibited (prevented).

Meanwhile, the reaching direction is the direction for allowing the developing solution 11 discharged from the discharging part 14 of the supply pipe 5 to reach the substrate 6 to be processed. Specifically, the reaching direction is as follows: by varying the discharging direction of the discharging part 14 of the supply pipe 5 as shown in FIG. 3(B) so that the developing solution 11 discharged from the discharging part 14 of the supply pipe 5 can reach the substrate 6 to be processed, supply of the developing solution 11 to the substrate 6 to be processed is allowed.

<3. Operation of the Resist Developing Device (Method for Manufacturing an Imprint Mold)>

Next, the operation of the resist developing device 1 configured as described above (namely the method for manufacturing an imprint mold) will be described. The operation of the resist developing device 1 is performed based on a control instruction given from the abovementioned main control part.

First, regarding the developing solution supply part 2, by controlling the temperature of the developing solution 11 stored in the storage part 4 by a liquid temperature control means (not shown), the temperature of the developing solution 11 in the storage part 4 is maintained to a set temperature (for example −10° C.). Meanwhile, regarding the development processing part 3, the substrate 6 to be processed is supported in the fixed state by vacuum suction, etc., after the substrate 6 to be processed is placed on the spin chuck 21 of the holding part 8. Next, the spindle shaft 22 is rotated by driving the rotation drive part 9. Thus, the spindle chuck 21 supporting the substrate 6 to be processed is set in a rotation state rotated integrally with the spindle shaft 22.

In this state, the pump 16 is driven and immediately thereafter the open/close valve 15 is set in an open state, to thereby take-in the developing solution 11 in the storage part 4 into the supply pipe 5, and send the developing solution 11 toward the development processing part 3 through the supply pipe 5. Then, the developing solution 11 is discharged from the discharging part 14 positioned on a lowermost stream side of the supply pipe 5.

At this time, an influence of an environment temperature is strongly given to the attachment part of the open/close valve 15 and the piping portion of the supply pipe 5 on the downstream side, which are not covered with the jacket 17, and the temperature is not controlled. Further, if the whole part of the piping portion of the supply pipe 5 is covered with the jacket 17, a large scale facility is required to thereby increase a facility cost. Therefore, the temperature of the developing solution passing through the supply pipe may varied in some cases exceeding a suitable temperature range.

Here, the abovementioned “suitable temperature range” is the range required for the developing solution 11 actually supplied to the substrate 6 to be processed, for obtaining a pattern satisfying a desired resolution by the development processing.

Therefore, in the first position-change operating step before discharging the developing solution 11, the discharging direction of the discharging part 14 connected to the bellow part 5A is varied and stopped (waited) in the non-reaching direction for not allowing the developing solution 11 to reach the substrate 6 to be processed by pulling the wire 31 vertically downward by driving the drive part 34 (see FIG. 1). In this state, the developing solution 11 is discharged from the discharging part 14 of the supply pipe 5 until the temperature of the developing solution 11 passing through the supply pipe 5 becomes within the suitable temperature range.

When the temperature of the developing solution 11 passing through the supply pipe 5 becomes within the suitable temperature range, in the second position-change operating step after the first position change operating step, the discharging direction of the discharging part 14 connected to the bellow part 5A is varied in the reaching direction for allowing the developing solution 11 to reach the substrate 6 to be processed by the elastic force of the bellow part 5A by loosening the wire 31 vertically upward by the drive part 34, and in this state, the developing solution 11 is discharged from the discharging part 14 of the supply pipe 5. Thus, the developing solution 11 reaches the surface (upper surface) of the substrate 6 to be processed while being rotated. At this time, in the surface of the substrate 6 to be processed, the developing solution 11 is supposed to reach a region including at least the central part of the substrate 6 to be processed. Then, the developing solution 11 is evenly supplied to the whole part of the substrate 6 to be processed by a centrifugal force caused by the rotation of the substrate 6 to be processed. As a result, a soluble portion of the exposed resist film formed on the surface of the substrate 6 to be processed is dissolved and removed by a chemical reaction with the developing solution 11. Thus, the development processing is applied to the substrate 6 to be processed in the processing chamber 7.

Incidentally, when the resist film is formed using a negative resist for forming and exposing the resist film on the substrate 6 to be processed, a portion not exposed by exposure processing performed thereafter is the soluble portion. Meanwhile, when the resist film is formed using a positive resist, a portion not exposed by the exposure processing performed thereafter is the soluble portion. Accordingly, if the development processing is performed, the following resist pattern is obtained. Namely, when the negative resist is used, the resist pattern as the reverse of the exposure pattern can be obtained. Further, when the positive resist is used, the resist pattern as the exposure pattern can be obtained.

After the development processing is ended, the open/close valve 15 is switched from the open state to the close state, to thereby stop the supply of the developing solution 11 and thereafter stop the drive of the pump 16 as needed. Next, a rinse liquid is supplied to the substrate 6 to be processed by a rinse liquid supply part not shown, to thereby perform rinse processing. Next, after the rinse processing is ended, supply of the rinse liquid is stopped and spin drying is performed.

Thereafter, when the next substrate 6 to be processed is developed, the already developed substrate 6 to be processed is removed from the spin chuck 21 of the holding part 8, and replacing with this substrate to be processed, an undeveloped substrate 6 to be processed is held by the holding part 8 similarly to the above case. Thereafter, the development processing, the rinse processing, and the drying processing (spin drying) are performed to the undeveloped substrate 6 to be processed.

In the operation of the abovementioned resist development device 1, supply of the developing solution 11 is maintained to be stopped by the open/close valve 15 in a period from end of the development processing of the (n)-th (n is a natural number) substrate 6 to be processed to start of the development processing of the (n+1)-th substrate to be processed. Therefore, the developing solution 11 is remained inside of the supply pipe 5 during this period. Then, when the development processing of the (n+1)-th substrate 6 to be processed is started, the developing solution 11 remained in the supply pipe 5 until then is supplied toward the substrate 6 to be processed from the discharging part 14 of the supply pipe 5.

In the abovementioned case, explanation is given for a case that the development processing is applied to the substrate 6 to be processed one by one in the resist developing device 1. Meanwhile, when the development processing is applied to a plurality of substrate 6 to be processed in the resist developing device 1, the description of “development processing of the n-th substrate 6 to be processed” is replaced by the description of “development processing of the n-numbers of times of substrate 6 to be processed”.

In this case, the temperature of the developing solution 11 remained in the supply pipe 5 is maintained to be equivalent to the temperature of the developing solution 11 in the storage part 4 by the jacket 17. However, the influence of the environment temperature is sometimes strongly effected in the attachment part of the open/close valve 15 and the piping portion of the supply pipe 5 on the downstream side not covered with the jacket 17, and therefore the temperature cannot be controlled with high precision. Therefore, if the supply of the developing solution 11 is stopped after end of the development processing of the substrate 6 to be processed, particularly the temperature of the developing solution 11 remained in the middle of the piping of the piping of the supply pipe 5 in the processing chamber 7 is gradually varied under the influence of the environment temperature (such as a room temperature). Further, if the remaining time of the developing solution 11 is prolonged, a temperature variation becomes large by the prolonged time. Accordingly, there is also a case that the temperature of the remained developing solution 11 is varied exceeding the suitable temperature range. Further, even if the developing solution 11 is not remained (empty state) in the supply pipe 5 on the downstream side of the attachment part of the open/close valve 15, due to the variation of the temperature of the supply pie 5 under the influence of the environment temperature, the temperature of the developing solution passing therethrough may exceed the suitable temperature range.

In order to cope with the case that the temperature of the developing solution 11 is varied exceeding the suitable temperature range, the main control part of the resist developing device 1 controls the operation of the resist developing device 1 so as to perform the first position-change operating step and the second position-change operating step for varying the discharging direction of the discharging part 14 described later.

Control of the operation by the abovementioned main control part may be performed every time the substrate 6 to be processed held by the holding part 8 is replaced. However, when such a replacement is done in a short time, the influence of the environment temperature becomes small accordingly, and therefore the abovementioned first position-change operating step and the second position-change operating step are not necessarily required to be performed. In such a case, it can be considered that the control of the position-change operation is applied to only a case that a previously determined condition is satisfied.

For example, it is considered that, an elapsed time (remaining time of the developing solution 11) from stop of the supply of the developing solution 11 by a closing operation of the open/close valve 15 is measured by a timer, etc., and only in a case that a measured value exceeds a previously determined allowable time, the abovementioned control of the position-change operation is applied. The “allowable time” mentioned here is the time set under a condition that the temperature of the developing solution 11 supplied through the supply pipe is set under a condition of not exceeding the abovementioned suitable temperature range, even if the temperature of the developing solution 11 remained in the middle of the supply pipe 5 (particularly the piping portion not covered with the jacket 17), and the temperature of the supply pipe 5 not covered with the jacket 17, are varied under the influence of the environment temperature.

Further, it is also applicable that a temperature sensor not shown is provided at a part not covered with the jacket 17, for example at the discharging part 14, etc., of the supply pipe 5, and the temperature of the developing solution 11 in the supply pipe 5 is estimated from a value detected by the temperature sensor, and when the temperature is not within the suitable temperature range, the first position-change operating step may be executed, and when the temperature is within the suitable temperature range, the second position-change operating step may be executed.

When the abovementioned control of the position-change operation is applied, more specifically the first position-change operating step and the second position-change operating step are performed by the following procedure. Here, the operation of the resist developing device 1 is described on the assumption of the case that the developing solution 11 is remained in the piping portion on the downstream side of the attachment part of the open/close valve 15 in the piping direction of the supply pipe 5.

First, the wire 31 is pulled vertically downward by driving the drive part 34, before the development processing is applied to the next substrate 6 to be processed. Thus, the direction of the force is converted to the d1 direction (see FIG. 3(A)). Therefore, the discharging direction of the discharging part 14 connected to the bellow part 5A is varied in the non-reaching direction.

Then, when the discharging direction of the discharging part 14 reaches the non-reaching direction, drive of the drive part 34 is stopped. Thus, as shown in FIG. 3(A), the discharging part 14 is set at the non-reaching direction for not allowing the developing solution to reach the substrate 6 to be processed.

Next, the open/close valve 15 is set in the open state and the pump 16 is driven while rotating the substrate 6 to be processed similarly to the abovementioned case, to thereby discharge the developing solution 11 from the discharging part 14 of the supply pipe 5. Then, the developing solution (called “remained developing solution” hereafter) remained in the middle of the piping of the supply pipe 5 is discharged first from the discharging part 14 of the supply pipe 5. However, as shown in FIG. 3 (A), the discharging direction of the discharging part 14 is varied in the non-reaching direction, and therefore there is no supplying the remained developing solution 11 to the substrate 6 to be processed. This is the first position-change operating step.

In the abovementioned first position-change operating step, the whole amount or more of the developing solution 11 remained in the supply pipe 5 is preferably discharged from the discharging part 14 of the supply pipe 5 without allowing it to reach the substrate 6 to be processed. Further, in the abovementioned first position-change operating step, the developing solution 11 is preferably discharged with an amount required for the temperature of the supply pipe 5 itself to reach a level (low temperature state) close to the temperature of the developing solution 11 in the storage part 4, under the influence of a low temperature of the developing solution 11 flowing through the supply pipe 5. However, the present invention is not limited thereto, and the developing solution 11 whose temperature is not properly controlled and remained in the supply pipe 5 on the downstream side of the attachment part of the open/close valve 15 before the first position-change operating step is started, may be discharged in the first position-change operating step.

Thereafter, the discharging direction of the discharging part 14 is varied in the reaching direction from the non-reaching direction after in the stage of discharging a specific amount of the developing solution 11 including the remained developing solution from the supply pipe 5.

Specifically, the wire 31 is loosened vertically upward by driving the drive part 34. Thus, the direction of the force is converted to the d2 direction (see FIG. 3(B)) by the direction converting mechanism 32, and therefore the discharging direction of the discharging part 14 connected to the bellow part 5A is varied in the reaching direction by the elastic force of the bellow part 5A. Thereafter, when the discharging direction of the discharging part 14 reaches the previously set reaching direction, the drive of the drive part 34 is stopped.

Thus, as shown in FIG. 3(B), the discharging direction of the discharging part 14 of the supply pipe 5 is set in a state that it stops in the reaching direction for allowing the developing solution to reach the substrate 6 to be processed. At this time, the discharge of the developing solution 11 may be stopped temporarily or may be continued. In any case, the developing solution 11 is discharged from the discharging part 14 of the supply pipe 5 in a state that the discharging direction of the discharging part 14 of the supply pipe 5 is varied in the reaching direction. This is the second position-change operating step.

In this case, the developing solution 11 discharged from the discharging part 14 of the supply pipe 5 surely reaches the substrate 6 to be processed. Accordingly, the developing solution 11 supplied to the substrate 6 to be processed is the developing solution whose temperature is controlled to be constant in the storage part 4, including almost no remained developing solution.

<4. Effect of an Embodiment>

According to the method for manufacturing an imprint mold and the resist developing device 1 of an embodiment of the present invention, the following effect can be obtained.

Namely, regarding the developing solution 11 discharged from the discharging part 14 of the supply pipe 5, the mechanism of varying the discharging direction of the discharging part 14 of the supply pipe 5 is provided, and by this position-change mechanism, the reaching direction and the non-reaching direction of the developing solution discharged from the discharging part 14 to the substrate 6 to be processed can be controlled, so that only the developing solution 11 within the suitable temperature range can be supplied to the substrate 6 to be processed by the position-change mechanism.

Therefore, even in a case that the temperature of the developing solution 11 passing through the supply pipe 5 first which is not covered with the jacket 17, the temperature of the developing solution 11 remained in the middle of the piping of the supply pipe 5, or/and the temperature of the supply pipe 5 not covered with the jacket 17, are varied under the influence of the environment temperature, the developing solution 11 with temperature variation suppressed can be supplied to the substrate 6 to be processed. Accordingly, unevenness, etc., in dissolution during development caused by the temperature variation of the developing solution 11 can be suppressed. Therefore, the pattern can be formed with high resolution.

Particularly, when the time after the development processing is applied to one preceding substrate 6 to be processed until the development processing is applied to the next substrate 6 to be processed (called a “time interval” hereafter) is longer than the abovementioned allowable time, the abovementioned first position-change operating step and the second position-change operating step are sequentially performed, to thereby apply development processing to the next substrate 6 to be processed without supplying the developing solution 11 at a discharge initial time in which a large temperature variation occurs. Therefore, the development processing can be stably applied to the substrate 6 to be processed.

Note that the description of “the development processing is applied to the next substrate to be processed after applying development processing to one preceding substrate to be processed” means the description of “the development processing is applied to the substrate 6 to be processed of the (n+1) numbers of times after applying the development processing to the substrate 6 to be processed of n numbers of times” as described above.

As a situation in which the time interval of processing is longer than the allowable time, for example, the following cases can be considered: switch of a manufacturing lot or process set-up, etc., is required, or maintenance, etc., of the resist developing device is required.

Further particularly, when the substrate 6 to be processed is a mold substrate for nano-imprint, a fine irregular pattern can be formed with high precision by a smaller temperature variation of the developing solution 11 supplied to the substrate 6 to be processed. This is because when the irregular pattern is formed on the mold substrate for nano-imprint, reduction of the resolution of the development caused by a pattern collapses in out-of-shape state at an edge portion of the pattern can be prevented, by applying the development processing, at a low temperature of the developing solution.

The “irregular pattern” called here indicates the pattern formed on the substrate 6 to be processed using the development processing. Namely, the irregular pattern includes a resist pattern formed on the substrate 6 to be processed and also includes another pattern layer on the substrate 6 to be processed formed using the resist pattern as a mask, and further includes an irregular pattern formed on the substrate 6 to be processed itself by etching, etc., using the resist pattern as a mask.

Further, the imprint mold in this specification includes not only a mold substrate into which the irregular pattern is engraved, but also a substrate attached with the resist pattern corresponding to the master pattern mold, and a substrate attached with the other pattern layer.

When the development processing is performed particularly at a temperature of 0° C. or less, the effect is remarkably exhibited. In such a circumstance, if the abovementioned structure of the resist developing device 1 is employed, the developing solution 11 can be supplied to the substrate 6 to be processed, with the temperature of the developing solution maintained to 0° C. or less and the temperature variation of the developing solution 11 suppressed. Therefore, when the mold substrate for imprint is developed as the substrate 6 to be processed, the fine irregular pattern of a nano-level can be realized.

Further, the position-change mechanism which is a position-change part for varying the discharging direction of the discharging part 14 can be realized by an extremely simple device structure such as the bellow part 5A provided on the supply pipe 5, the wire 31, the direction converting mechanism 32, and the drive part 34, and also the abovementioned effect can be exhibited at a low cost.

The technical scope of the present invention is not limited to the abovementioned embodiment, and includes various modifications and improvements in the scope capable of deriving a specific effect obtained by constituting features of the present invention and a combination of them.

### Description of Signs and Numerals

1 Resist developing device
2 Developing solution supply part
3 Development processing part
4 Storage part
5 Supply part
5A Bellow part
6 Substrate to be processed
7 Processing chamber
8 Holding part
11 Developing solution
14 Discharging part
17 Jacket
31 Wire
32 Direction converting mechanism
34 Drive part

1. A method for manufacturing an imprint mold for forming an irregular pattern on a substrate to be processed, using a development processing performed by discharging a developing solution to the substrate to be processed through a supply pipe, the method comprising:
a first position-change operating step of discharging the developing solution by varying a discharging direction in a non-reaching direction for not allowing the developing solution to reach the substrate to be processed when a temperature of the developing solution in the supply pipe is not within a suitable temperature range; and
a second position change operating step of discharging the developing solution by varying the discharging direction in a reaching direction for allowing the developing solution to reach the substrate to be processed, when the temperature of the discharged developing solution is within a suitable temperature range, after the first position-change operating step.

2. The method of claim 1, wherein the first position-change operating step and the second position-change operating step are performed in case of the longer time period than an allowable one between the finishing the preceding substrate development processing and the executing the next substrate development processing.

3. The method of claim 2, comprising:
performing the first position-change operating step and the second position-change operating step in a period from applying the development processing to the one preceding substrate to be processed until the development processing is applied to the next substrate to be processed.

4. The method of claim 3, wherein in the first position-change operating step, a total amount or more of the developing solution remained in the supply pipe is discharged without allowing it to reach the substrate to be processed.

5. The method of claim 4, wherein the substrate to be processed is a mold substrate for nano-imprint.

6. The method of claim 5, wherein the suitable temperature range is 0° C. or less.

7. A resist developing device for applying development processing to a substrate to be processed by supplying a developing solution to the substrate to be processed, the device comprising:
a storage part configured to store the developing solution, with a temperature controlled to a constant temperature;
a holding part configured to hold the substrate to be processed;
a supply pipe configured to form a flow passage for flowing the developing solution stored in the storage part, and having a discharging part for discharging the developing solution flowed through the flow passage, and configured to supply the developing solution to the substrate to be processed by discharging the developing solution from the discharging part toward the substrate to be processed which is held by the holding part; and
a position-change part configured to perform the first position-change operation for varying a discharging direction of the discharging part in a non-reaching direction for not allowing the developing solution discharged from the discharging part of the supply pipe to reach the substrate to be processed, and a second position-change operation for varying the discharging direction of the discharging part in a reaching direction for allowing the developing solution discharged from the discharging part of the supply pipe to reach the substrate to be processed.

8. The resist developing device of claim 7, wherein in the first position-change operation, a total amount or more of the developing solution remained in the supply pipe before the first position-change operation, is discharged from the discharging part without allowing it to reach the substrate to be processed.

9. The device of claim 8, wherein a temperature adjuster is provided at a part of the supply pipe.

10. The device of claim 9, wherein the substrate to be processed which is an object to which the developing solution is supplied, is a mold substrate for nano-imprint.

11. The device of claim 10, wherein the temperature of the developing solution stored in the storage part is controlled to a low temperature of 0° C. or less.
